(19) United States
(12) Patent Application Publication
(10) Pub. No.: US 2025/0303265 A1
(43) Pub. Date: Oct. 2, 2025

(54) MOTORIZED ROLLER BLADE DEVICE

(71) Applicant: James Porter, Fernley, NV (US)

(72) Inventor: James Porter, Fernley, NV (US)

(21) Appl. No.: 18/624,928

(22) Filed: Apr. 2, 2024

(51) Int. Cl. A63C 17/12; A63C 17/06; A63C 17/26; B60L 53/16

(52) U.S. Cl. CPC A63C 17/12; A63C 17/06; A63C 17/26; B60L 53/16; A63C 2203/12; A63C 2203/14; A63C 2203/22

(57) ABSTRACT

A motorized roller blade device for automatically urging rollerblades along a support surface includes a rollerblade and a pair of motors each integrated into a respective one of a plurality of rollers of the rollerblade. Each of the pair of motors rotates the respective roller when the pair of motors is turned on to facilitate the rollerblade to be driven along the support surface. A control unit is mounted to the boot for actuating or de-actuating each of the pair of motors. A remote control is held by the user of the rollerblade and the remote control is in remote communication with the control unit for remotely actuating or de-actuating the pair of motors to facilitate the user to remotely control the pair of motors.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to roller blade devices and more particularly pertains to a new roller blade device for facilitating powered transportation for a user wearing rollerblades. The device includes a rollerblade that has a pair of motors each integrated into a respective one of a plurality of rollers on the rollerblade. The device further includes a remote control for remotely controlling the motors for adjusting a speed of the motors.

### (2) Description of Related Art Including Information Disclosed Under 37 CFR 1.97 and 1.98

The prior art relates to roller blade devices including a powered roller blade device that includes a roller blade that has an internal combustion motor for driving rollers on the roller blade and motorized roller blade device that includes a roller blade that has an externally mounted electric motor and a drive wheel which frictionally engages a roller on the roller blade for driving the roller and a motorized roller skate device that includes a pair of roller skates that includes an electric motor integrated into the roller skates and a steering mechanism for steering the roller skates. In no instance does the prior art disclose a powered roller blade that includes a pair of electric motors which are each integrated into a respective roller and a remote control for remotely controlling the pair of electric motors.

### BRIEF SUMMARY OF THE INVENTION

An embodiment of the disclosure meets the needs presented above by generally comprising a rollerblade and a pair of motors each integrated into a respective one of a plurality of rollers of the rollerblade. Each of the pair of motors rotates the respective roller when the pair of motors is turned on to facilitate the rollerblade to be driven along the support surface. A control unit is mounted to the boot for actuating or de-actuating each of the pair of motors. A remote control is held by the user of the rollerblade and the remote control is in remote communication with the control unit for remotely actuating or de-actuating the pair of motors to facilitate the user to remotely control the pair of motors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a motorized roller blade device according to an embodiment of the disclosure.

FIG. 2 is a bottom view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

FIG. 7 is a schematic view of an embodiment of the disclosure.

### DETAILED DESCRIPTION OF THE INVENTION

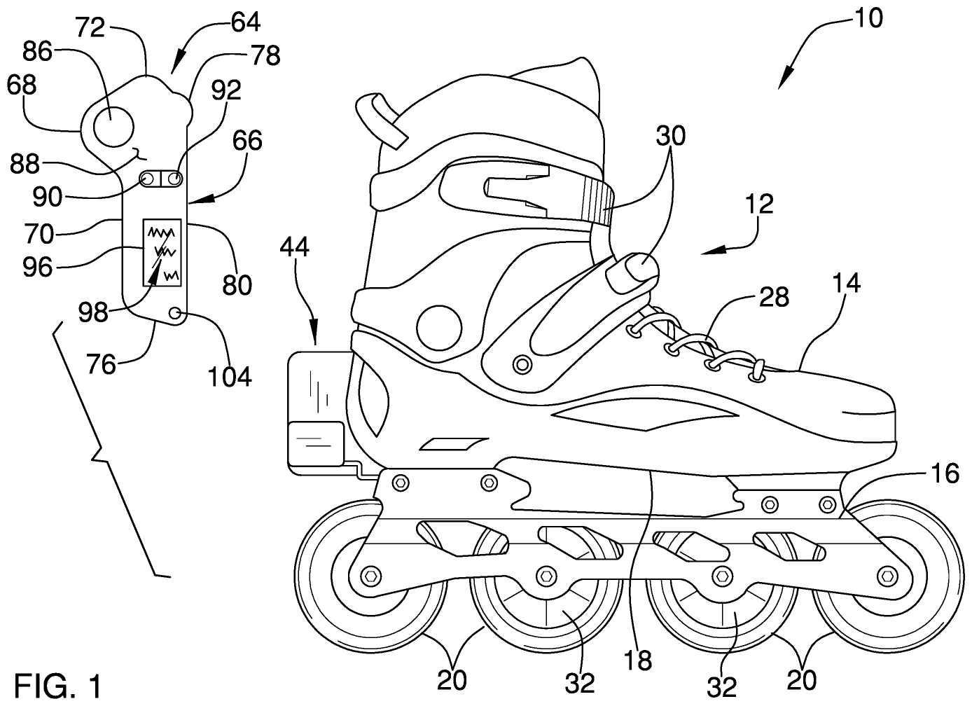

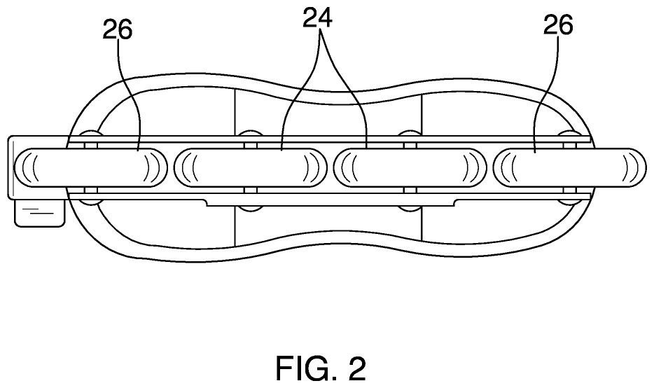

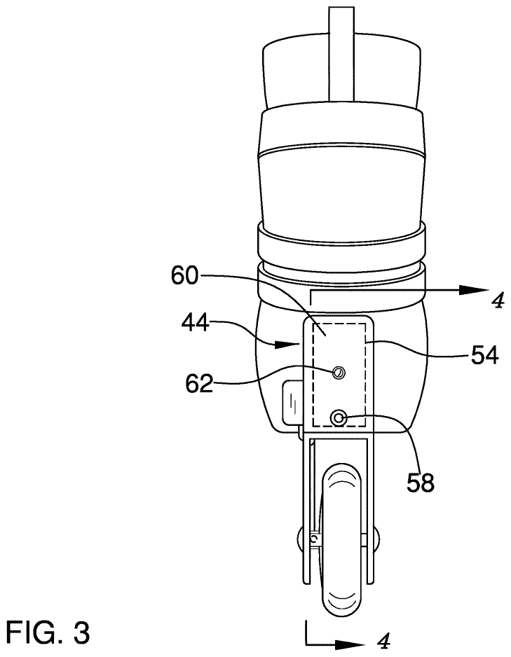

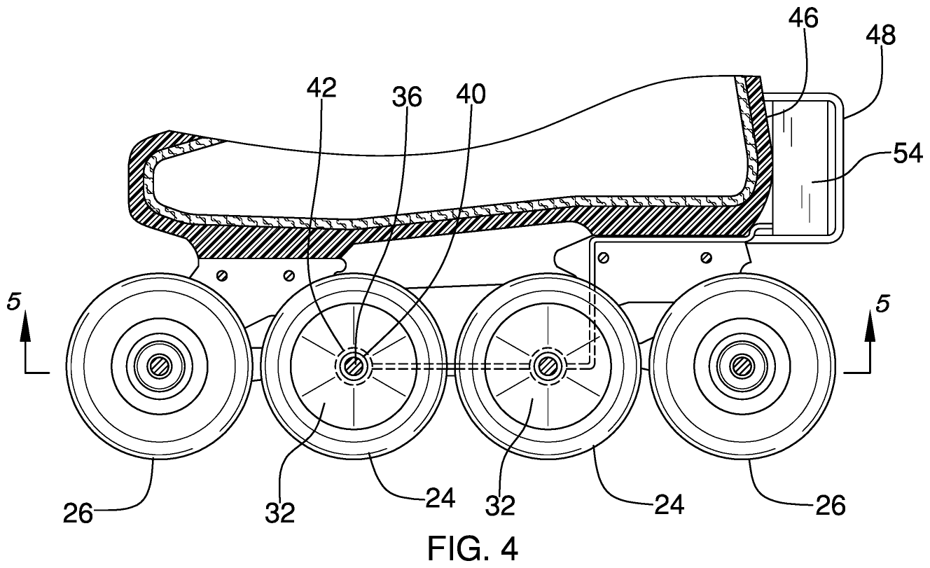

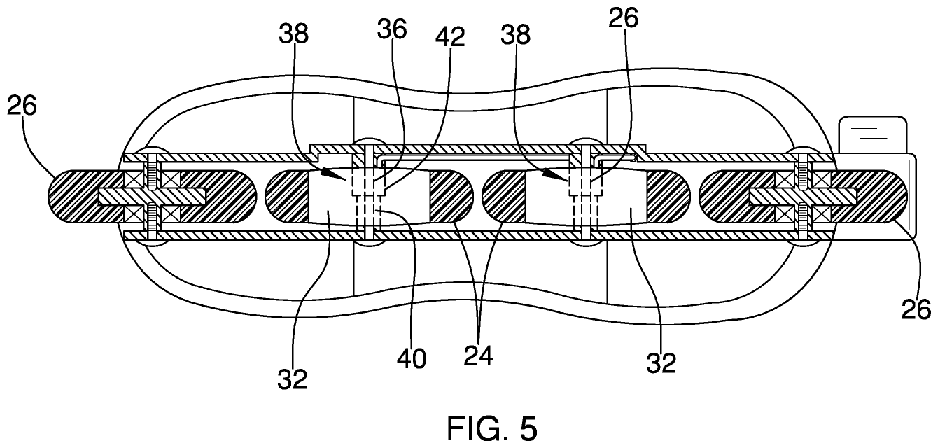

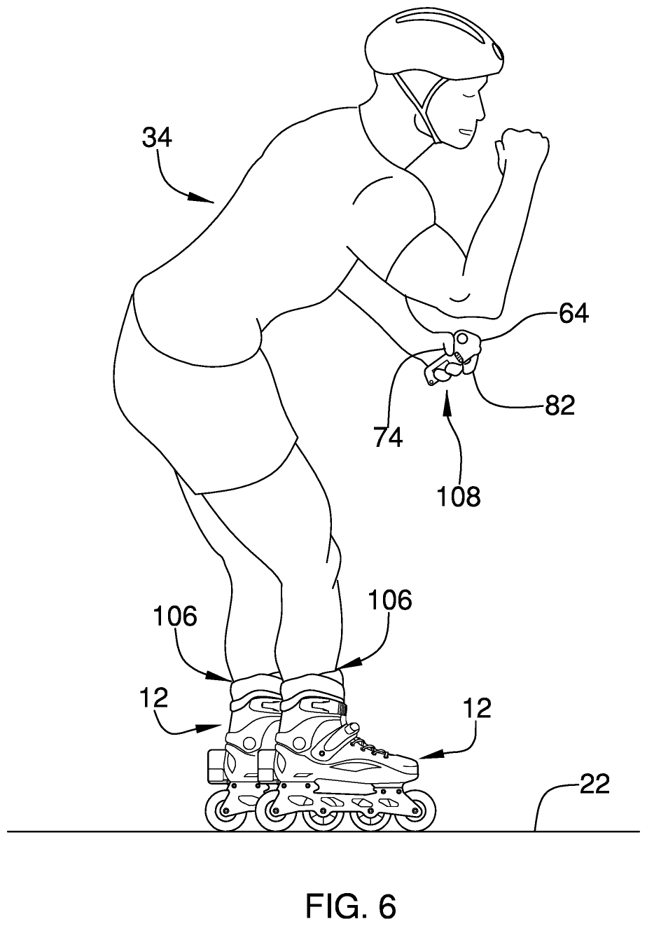

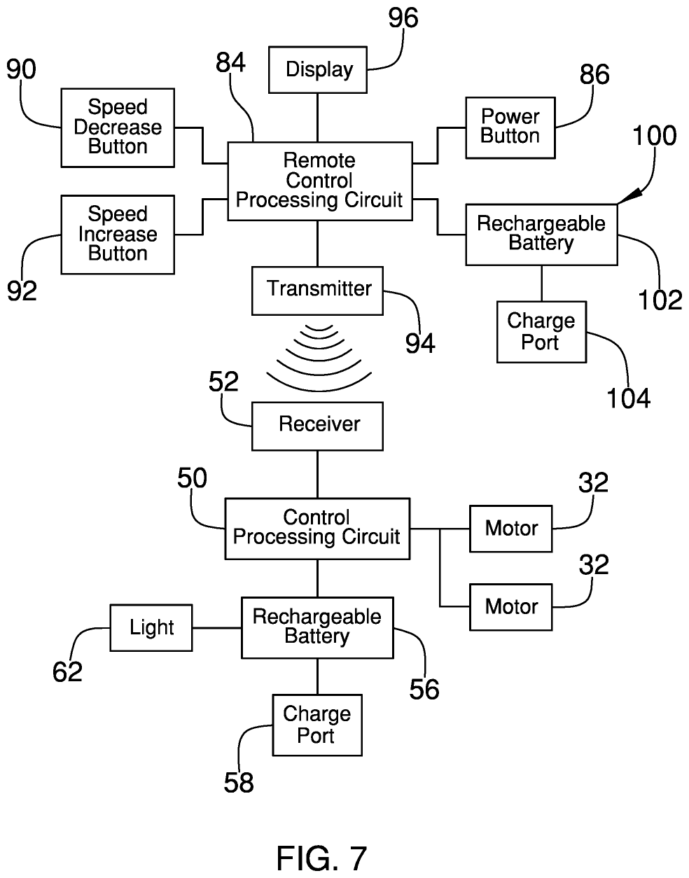

With reference now to the drawings, and in particular to FIGS. 1 through 7 thereof, a new roller blade device embodying the principles and concepts of an embodiment of the disclosure and generally designated by the reference numeral 10 will be described.

As best illustrated in FIGS. 1 through 7, the motorized roller blade device 10 generally comprises a rollerblade 12 that includes a boot 14 and a rail 16 attached to a sole 18 of the boot 14 and a plurality of rollers 20 each rotatably disposed on the rail 16. Each of the plurality of rollers 20 rolls along a support surface 22 such as a sidewalk, a roadway or other type of horizontal support surface. Additionally, the plurality of rollers 20 includes a pair of middle rollers 24 that is each positioned between a pair of end rollers 26. Furthermore, the boot 14 may include lacing 28 and buckling straps 30 and other hardware commonly associated with roller blades.

A pair of motors 32 is provided and each of the pair of motors 32 is integrated into a respective one of the plurality of rollers 20. Each of the pair of motors 32 rotates the respective roller when the pair of motors 32 is turned on to facilitate the rollerblade 12 to be driven along the support surface 22 such that a user 34 of the rollerblade 12 does not have to exert energy to travel along the support surface 22. Each of the pair of motors 32 is integrated into a respective one of the pair of middle rollers 24 and each of the pair of middle rollers 24 includes an axle 36 which extends through a respective middle roller 24 and which engages the rail 16 for rotatably retaining the middle rollers 24 to the rail 16. Additionally, each of the pair of motors 32 includes a bearing 38 which includes a central cylinder 40 that is surrounded by an outer cylinder 42. The axle 36 of a respective one of the middle rollers 24 extends through the central cylinder 40 of the bearing 38 of a respective one of the pair of motors 32; the central cylinder 40 of the bearing 38 of each of the pair of motors 32 is affixed to the axle 36 of the respective middle roller 24. Furthermore, the outer cylinder 42 of each of the pair of motors 32 is engaged to the central cylinder 40 of a respective motor 32.

The outer cylinder 42 of a respective motor 32 rotates the central cylinder 40 of the respective motor 32 when the respective motor 32 is turned on thereby facilitating the respective motor 32 to rotate the respective middle roller 24. Moreover, the central cylinder 40 of the bearing 38 of a respective one of the pair of motors 32 freely rotates in the outer cylinder 42 of the bearing 38 of the respective motor 32 when the respective motor 32 is turned off. In this way each of the pair of motors 32 facilitates the user 34 to employ the rollerblade 12 in the conventional manner of employing rollerblades when the pair of motors 32 are turned off. Each of the pair of motors 32 may comprise a brushless electric motor or the like that is capable of rotating at a variety of rotational speeds.

A control unit 44 is mounted to the boot 14 and the control unit 44 is in communication with each of the pair of motors 32 for actuating or de-actuating each of the pair of motors 32. The control unit 44 is positioned on a heel 46 of the boot 14 and the control unit 44 comprises a control housing 48 that is mounted to the heel 46 of the boot 14. The control unit 44 includes a control processing circuit 50 that is positioned within the control housing 48; the control processing circuit 50 receives an actuate input and a de-actuate input and a speed increase input and a speed decrease input. Additionally, the control processing circuit 50 is electrically coupled to each of the pair of motors 32. Each of the pair of motors 32 is turned on when the control processing circuit 50 receives the actuate input and each of the pair of motors 32 is turned off when the control processing circuit 50 receives the de-actuate input. Furthermore, each of the pair of motors 32 is actuated to increase toward a maximum rotational speed when the control processing circuit 50 receives the speed increase command. Additionally, each of the pair of motors 32 is actuated to decrease toward a minimum rotational speed when the control processing circuit 50 receives the speed decrease command.

The control unit 44 includes a receiver 52 that is positioned within the control housing 48 and the receiver 52 is electrically coupled to the control processing circuit 50. The receiver 52 may comprise a radio frequency receiver or the like with an operational range of approximately 30.0 meters. The control unit 44 includes a control power supply 54 that is positioned within the control housing 48 and the control power supply 54 is electrically coupled to the control processing circuit 50. The control power supply 54 comprises a rechargeable battery 56 that is positioned in the control housing 48 and the rechargeable battery 56 is electrically coupled to the control processing circuit 50. The control power supply 54 includes a charge port 58 that is recessed into an outer wall 60 of the control housing 48 to insertably receive a plug of a charger. Additionally, the charge port 58 is electrically coupled to the rechargeable battery 56 for charging the rechargeable battery 56. The control power supply 54 includes a light 62, which may comprise a light emitting diode or the like, that is attached to an outer wall 60 of the control housing 48. The light 62 emit lights outwardly from the control housing 48 when the light 62 is turned on and the light 62 is electrically coupled to the rechargeable battery 56 such that the light 62 visually indicates when the rechargeable battery 56 is being charged.

A remote control 64 is provided which can be held by the user 34 of the rollerblade 12. The remote control 64 is in remote communication with the control unit 44 for remotely actuating or de-actuating the pair of motors 32 thereby facilitating the user 34 to remotely control the pair of motors 32. The remote control 64 comprises a remote control housing 66 which has a first lobe 68 extending away from a rear surface 70 of the remote control housing 66 at a point located adjacent to a top surface 72 of the remote control housing 66 such that the first lobe 68 is positioned over the user's thumb 74 when the user 34 grips the remote control housing 66. The remote control housing 66 is elongated between the top surface 72 and a bottom surface 76 of the remote control housing 66 and the top surface 72 is rounded. The remote control housing 66 has a second lobe 78 extending away from a front surface 80 of the remote control housing 66 at a point located adjacent to the top surface 72 such that the second lobe 78 is positioned under the user's forefinger 82 when the user 34 grips the remote control housing 66.

The remote control 64 includes a remote control processing circuit 84 that is positioned within the remote control housing 66. The remote control processing circuit 84 receives an on input and an off input and a speed decrease input and a speed decrease input. The remote control 64 includes a power button 86 that is movably integrated into a lateral surface 88 of the remote control housing 66. The power button 86 is positioned on the first lobe 68 such that the power button 86 can be manipulated with the user's thumb 74. The power button 86 is electrically coupled to the remote control processing circuit 84 and the remote control processing circuit 84 receives the on input when the power button 86 is initially depressed. Furthermore, the remote control processing circuit 84 receives the off input when the power button 86 is subsequently depressed.

The remote control 64 includes a speed decrease button 90 that is movably integrated into the lateral surface 88 of the remote control housing 66 which can be manipulated with the user's thumb 74. The speed decrease button 90 is electrically coupled to the remote control processing circuit 84 and the remote control processing circuit 84 receives the speed decrease input when the speed decrease button 90 is depressed. The remote control 64 includes a speed increase button 92 that is movably integrated into the lateral surface 88 of the remote control housing 66 which can be manipulated with the user's thumb 74. The speed increase button 92 is electrically coupled to the remote control processing circuit 84 and the remote control processing circuit 84 receives the speed increase input when the speed increase button 92 is depressed.

The remote control 64 includes a transmitter 94 that is positioned within the remote control housing 66 and the transmitter 94 is electrically coupled to the remote control 64 circuit. Additionally, the transmitter 94 is in wireless communication with the receiver 52 in the control housing 48 on the boot 14 of the roller blade. The transmitter 94 broadcasts an actuate command to the receiver 52 when the remote control processing circuit 84 receives the on input. Additionally, the control processing circuit 50 receives the on input when the receiver 52 receives the actuate command. The transmitter 94 broadcasts a de-actuate command to the receiver 52 when the remote control 64 processor receives the de-actuate command. Additionally, the control processing circuit 50 receives the off input when the receiver 52 receives the de-actuate command. The transmitter 94 broadcasts a speed increase command to the receiver 52 when the remote control 64 processor receives the speed increase input and the control processing circuit 50 receives the speed increase input when the receiver 52 receives the speed increase command. Continuing, the transmitter 94 broadcasts a speed decrease command to the receiver 52 when the remote control 64 processor receives the speed decrease input. Furthermore, the control processing circuit 50 receives the speed decrease input when the receiver 52 receives the speed decrease command. The transmitter 94 may comprise a radio frequency transmitter or the like with an operational range of approximately 30.0 meters.

The remote control 64 includes a display 96 which is disposed on the lateral surface 88 of the remote control housing 66 and the display 96 is electrically coupled to the remote control processing circuit 84. The display 96 displays indicia 98 comprising letters and words for visually communicating an operational status of the pair of motors 32, including the speed at which the motors 32 are turning and whether the motors 32 are turned on or off. Additionally, the display 96 may comprise a light emitting diode display or other type of electronic display.

The remote control 64 includes a remote power supply 100 that is integrated into the remote control housing 66 and the remote power supply 100 is electrically coupled to the remote control 64 circuit. The remote power supply 100 comprises a rechargeable battery 102 that is positioned within the remote control housing 66 and the rechargeable battery 102 of the remote power supply 100 is electrically coupled to the remote control processing circuit 84. Additionally, the remote power supply 100 includes a charge port 104 which is recessed into the lateral surface 88 of the remote control housing 66 to insertably receive a charge cord. The charge port 104 on the lateral surface 88 is electrically coupled to the rechargeable battery 102 in the remote control housing 66 for charging the rechargeable battery 102 in the remote control housing 66.

In use, a pair of the rollerblades 12 is provided which each includes the pair of motors 32 and the control unit 44. The user 34 wears the boot 14 of each of the pair of rollerblades 12 on a respective one of the user's feet 106 and the user 34 grips the remote control 64 with one of their hands 108. The user 34 can employ the rollerblades 12 without actuating the motors 32 to facilitate the rollerblades 12 to be employed in the conventional manner of rollerblading which involves the user 34 manually skating along the support surface 22. The user 34 can depress the power button 86 to turn on the pair of motors 32 in each of the pair of rollerblades 12 to facilitate the pair of motors 32 in each of the pair of rollerblades 12 to supply torque to urge the rollerblades 12 to travel along the support surface 22 without effort from the user 34. Furthermore, the user 34 can depress either the speed increase button or the speed decrease button 90 to either increase the speed of the motors 32 or decrease the speed of the motors 32, depending upon the user's 34 preference.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorized roller blade device for facilitating powered travel for a user while the user is wearing a pair of roller blades, said device comprising:
a rollerblade including a boot and a rail attached to a sole of said boot and a plurality of rollers each being rotatably disposed on said rail wherein each of said plurality of rollers is configured to roll along a support surface;
a pair of motors, each of said pair of motors being integrated into a respective one of said plurality of rollers, each of said pair of motors rotating said respective roller when said pair of motors is turned on wherein each of said pair of motors is configured to facilitate said rollerblade to be driven along the support surface such that a user of said rollerblade does not have to exert energy to travel along the support surface;
a control unit being mounted to said boot, said control unit being in communication with each of said pair of motors for actuating or deactuating each of said pair of motors, said control unit being positioned on a heel of said boot; and
a remote control being configured to be held by the user of said rollerblade, said remote control being in remote communication with said control unit for remotely actuating or de-actuating said pair of motors wherein said remote control is configured to facilitate the user to remotely control said pair of motors.

2. The device according to claim 1, wherein:
said plurality of rollers includes a pair of middle rollers each being positioned between a pair of end rollers;
each of said pair of motors is integrated into a respective one of said pair of middle rollers;
each of said pair of middle rollers includes an axle extending through a respective middle roller which engages said rail for rotatably retaining said middle rollers to said rail;
each of said pair of motors includes a bearing which includes a central cylinder being surrounded by an outer cylinder;
said axle of a respective one of said middle rollers extends through said central cylinder of said bearing of a respective one of said pair of motors having said central cylinder of said bearing of each of said pair of motors being affixed to said axle of said respective middle roller;
said outer cylinder of each of said pair of motors is engaged to said central cylinder of a respective motor;
said outer cylinder of a respective motor rotates said central cylinder of said respective motor when said respective motor is turned on thereby facilitating said respective motor to rotate said respective middle roller; and
said central cylinder of said bearing of a respective one of said pair of motors freely rotates in said outer cylinder of said bearing of said respective motor when said respective motor is turned off wherein each of said pair of motors is configured to facilitate the user to employ said rollerblade in the conventional manner of employing rollerblades when said pair of motors are turned off.

3. The device according to claim 1, wherein:
said control unit comprises a control housing being mounted to said heel of said boot;
said control unit comprises a control processing circuit being positioned within said control housing;
said control processing circuit receives an actuate input and a de-actuate input and a speed increase input and a speed decrease input;
said control processing circuit is electrically coupled to each of said pair of motors;
each of said pair of motors is turned on when said control processing circuit receives said actuate input;
each of said pair of motors is turned off when said control processing circuit receives said de-actuate input;
each of said pair of motors is actuated to increase toward a maximum rotational speed when said control processing circuit receives said speed increase command; and
each of said pair of motors is actuated to decrease toward a minimum rotational speed when said control processing circuit receives said speed decrease command.

4. The device according to claim 3, wherein:
said control unit comprises a receiver being positioned within said control housing, said receiver being electrically coupled to said control processing circuit; and
said control unit comprises a control power supply being positioned within said control housing, said control power supply being electrically coupled to said control processing circuit; and
said control power supply comprises:
a rechargeable battery being positioned in said control housing, said rechargeable battery being electrically coupled to said control processing circuit;
a charge port being recessed into an outer wall of said control housing wherein said charge port is configured to insertably receive a plug of a charger, said charge port being electrically coupled to said rechargeable battery for charging said rechargeable battery; and
a light being attached to an outer wall of said control housing wherein said light is configured to emit light outwardly from said control housing when said light is turned on, said light being electrically coupled to said rechargeable battery such that said light visually indicates when said rechargeable battery is being charged.

5. The device according to claim 1, wherein:
said remote control comprises a remote control housing having a first lobe extending away from a rear surface of said remote control housing at a point located adjacent to a top surface of said remote control housing wherein said first lobe is configured to be positioned over the user's thumb when the user grips said remote control housing;
said remote control housing is elongated between said top surface and a bottom surface of said remote control housing;
said top surface is rounded; and
said remote control housing has a second lobe extending away from a front surface of said remote control housing at a point located adjacent to said top surface wherein said second lobe is configured to be positioned under the user's forefinger when the user grips said remote control housing.

6. The device according to claim 5, wherein:
said remote control comprises a remote control processing circuit being positioned within said remote control housing;
said remote control processing circuit receives an on input and an off input and a speed decrease input and a speed decrease input;
said remote control comprises a power button being movably integrated into a lateral surface of said remote control housing;
said power button is positioned on said first lobe wherein said power button is configured to be manipulated with the user's thumb;
said power button is electrically coupled to said remote control processing circuit;
said remote control processing circuit receives said on input when said power button is initially depressed;
said remote control processing circuit receives said off input when said power button is subsequently depressed;
said remote control comprises a speed decrease button being movably integrated into said lateral surface of said remote control housing wherein said speed decrease button is configured to be manipulated with the user's thumb;
said speed decrease button is electrically coupled to said remote control processing circuit;
said remote control processing circuit receives said speed decrease input when said speed decrease button is depressed;
said remote control comprises a speed increase button being movably integrated into said lateral surface of said remote control housing wherein said speed increase button is configured to be manipulated with the user's thumb;
said speed increase button is electrically coupled to said remote control processing circuit;
said remote control processing circuit receives said speed increase input when said speed increase button is depressed; and
a transmitter being positioned within said remote control housing, said transmitter being electrically coupled to said remote control circuit.

7. The device according to claim 6, wherein:
said control unit includes control housing being located on said boot of said roller blade;
said control unit includes a control processing circuit and a receiver;
said transmitter is in wireless communication with said receiver in said control housing on said boot of said roller blade;
said transmitter broadcasting an actuate command to said receiver when said remote control processing circuit receives said on input;
said control processing circuit receiving an on input when said receiver receives said actuate command;
said transmitter broadcasts a de-actuate command to said receiver when said remote control processor receives said de-actuate command;
said control processing circuit receives an off input when said receiver receives said de-actuate command;
said transmitter broadcasts a speed increase command to said receiver when said remote control processor receives said speed increase input;
said control processing circuit receives said speed increase input when said receiver receives said speed increase command; and
said control processing circuit receives said speed decrease input when said receiver receives said speed decrease command.

8. The device according to claim 6, wherein:
said remote control comprises a display being disposed on said lateral surface of said remote control housing;
said display is electrically coupled to said remote control processing circuit, said display displaying indicia comprising letters and words for visually communication an operational status of said pair of motors; and
a remote power supply being integrated into said remote control housing;
said remote power supply is electrically coupled to said remote control circuit;
said remote power supply comprising:
a rechargeable battery being positioned within said remote control housing, said rechargeable battery of said remote power supply being electrically coupled to said remote control processing circuit; and
a charge port being recessed into said lateral surface of said remote control housing wherein said charge port on said lateral surface is configured to insertably receive a charge cord, said charge port on said lateral surface being electrically coupled to said rechargeable battery in said remote control housing for charging said rechargeable battery in said remote control housing.

9. A motorized roller blade device for facilitating powered travel for a user while the user is wearing a pair of roller blades, said device comprising:
a rollerblade including a boot and a rail attached to a sole of said boot and a plurality of rollers each being rotatably disposed on said rail wherein each of said plurality of rollers is configured to roll along a support surface, said plurality of rollers including a pair of middle rollers each being positioned between a pair of end rollers;
a pair of motors, each of said pair of motors being integrated into a respective one of said plurality of rollers, each of said pair of motors rotating said respective roller when said pair of motors is turned on wherein each of said pair of motors is configured to facilitate said rollerblade to be driven along the support surface such that a user of said rollerblade does not have to exert energy to travel along the support surface, each of said pair of motors being integrated into a respective one of said pair of middle rollers, each of said pair of middle rollers including an axle extending through a respective middle roller which engages said rail for rotatably retaining said middle rollers to said rail, each of said pair of motors including a bearing which includes a central cylinder being surrounded by an outer cylinder, said axle of a respective one of said middle rollers extending through said central cylinder of said bearing of a respective one of said pair of motors having said central cylinder of said bearing of each of said pair of motors being affixed to said axle of said respective middle roller, said outer cylinder of each of said pair of motors being engaged to said central cylinder of a respective motor, said outer cylinder of a respective motor rotating said central cylinder of said respective motor when said respective motor is turned on thereby facilitating said respective motor to rotate said respective middle roller, said central cylinder of said bearing of a respective one of said pair of motors freely rotating in said outer cylinder of said bearing of said respective motor when said respective motor is turned off wherein each of said pair of motors is configured to facilitate the user to employ said rollerblade in the conventional manner of employing rollerblades when said pair of motors are turned off;
a control unit being mounted to said boot, said control unit being in communication with each of said pair of motors for actuating or de-actuating each of said pair of motors, said control unit being positioned on a heel of said boot, said control unit comprising:
a control housing being mounted to said heel of said boot;
a control processing circuit being positioned within said control housing, said control processing circuit receiving an actuate input and a de-actuate input and a speed increase input and a speed decrease input, said control processing circuit being electrically coupled to each of said pair of motors, each of said pair of motors being turned on when said control processing circuit receives said actuate input, each of said pair of motors being turned off when said control processing circuit receives said de-actuate input, each of said pair of motors being actuated to increase toward a maximum rotational speed when said control processing circuit receives said speed increase command, each of said pair of motors being actuated to decrease toward a minimum rotational speed when said control processing circuit receives said speed decrease command;
a receiver being positioned within said control housing, said receiver being electrically coupled to said control processing circuit; and
a control power supply being positioned within said control housing, said control power supply being electrically coupled to said control processing circuit, said control power supply comprising:
a rechargeable battery being positioned in said control housing, said rechargeable battery being electrically coupled to said control processing circuit;
a charge port being recessed into an outer wall of said control housing wherein said charge port is configured to insertably receive a plug of a charger, said charge port being electrically coupled to said rechargeable battery for charging said rechargeable battery; and
a light being attached to an outer wall of said control housing wherein said light is configured to emit light outwardly from said control housing when said light is turned on, said light being electrically coupled to said rechargeable battery such that said light visually indicates when said rechargeable battery is being charged; and
a remote control being configured to be held by the user of said rollerblade, said remote control being in remote communication with said control unit for remotely actuating or de-actuating said pair of motors wherein said remote control is configured to facilitate the user to remotely control said pair of motors, said remote control comprising:
a remote control housing having a first lobe extending away from a rear surface of said remote control housing at a point located adjacent to a top surface of said remote control housing wherein said first lobe is configured to be positioned over the user's thumb when the user grips said remote control housing, said remote control housing being elongated between said top surface and a bottom surface of said remote control housing, said top surface being rounded, said remote control housing having a second lobe extending away from a front surface of said remote control housing at a point located adjacent to said top surface wherein said second lobe is configured to be positioned under the user's forefinger when the user grips said remote control housing;
a remote control processing circuit being positioned within said remote control housing, said remote control processing circuit receiving an on input and an off input and a speed decrease input and a speed decrease input;
a power button being movably integrated into a lateral surface of said remote control housing, said power button being positioned on said first lobe wherein said power button is configured to be manipulated with the user's thumb, said power button being electrically coupled to said remote control processing circuit, said remote control processing circuit receiving said on input when said power button is initially depressed, said remote control processing circuit receiving said off input when said power button is subsequently depressed;
a speed decrease button being movably integrated into said lateral surface of said remote control housing wherein said speed decrease button is configured to be manipulated with the user's thumb, said speed decrease button being electrically coupled to said remote control processing circuit, said remote control processing circuit receiving said speed decrease input when said speed decrease button is depressed;
a speed increase button being movably integrated into said lateral surface of said remote control housing wherein said speed increase button is configured to be manipulated with the user's thumb, said speed increase button being electrically coupled to said remote control processing circuit, said remote control processing circuit receiving said speed increase input when said speed increase button is depressed;
a transmitter being positioned within said remote control housing, said transmitter being electrically coupled to said remote control circuit, said transmitter being in wireless communication with said receiver in said control housing on said boot of said roller blade, said transmitter broadcasting an actuate command to said receiver when said remote control processing circuit receives said on input, said control processing circuit receiving said on input when said receiver receives said actuate command, said transmitter broadcasting a de-actuate command to said receiver when said remote control processor receives said de-actuate command, said control processing circuit receiving said off input when said receiver receives said de-actuate command, said transmitter broadcasting a speed increase command to said receiver when said remote control processor receives said speed increase input, said control processing circuit receiving said speed increase input when said receiver receives said speed increase command, said control processing circuit receiving said speed decrease input when said receiver receives said speed decrease command;
a display being disposed on said lateral surface of said remote control housing, said display being electrically coupled to said remote control processing circuit, said display displaying indicia comprising letters and words for visually communication an operational status of said pair of motors; and
a remote power supply being integrated into said remote control housing, said remote power supply being electrically coupled to said remote control circuit, said remote power supply comprising:
a rechargeable battery being positioned within said remote control housing, said rechargeable battery of said remote power supply being electrically coupled to said remote control processing circuit; and
a charge port being recessed into said lateral surface of said remote control housing wherein said charge port on said lateral surface is configured to insertably receive a charge cord, said charge port on said lateral surface being electrically coupled to said rechargeable battery in said remote control housing for charging said rechargeable battery in said remote control housing.
